(19) United States
(12) Patent Application Publication
(10) Pub. No.: US 2024/0391006 A1
(43) Pub. Date: Nov. 28, 2024

(54) CORRUGATING ROLLER MANUFACTURING METHOD, CORRUGATING ROLLER MANUFACTURING APPARATUS, AND CORRUGATING ROLLER

(71) Applicant: BHS Corrugated Maschinen- und Anlagenbau GmbH, Weiherhammer (DE)

(72) Inventors: Markus SCHELL, Weiden (DE); Christian BERNDT, Schnaittenbach (DE)

(21) Appl. No.: 18/674,584

(22) Filed: May 24, 2024

(30) Foreign Application Priority Data
May 26, 2023 (DE) 102023204993.7

(51) Int. Cl. B23F 7/00; B23F 23/12

(52) U.S. Cl. CPC B23F 7/00; B23F 23/12

(57) ABSTRACT

The present application relates to a method and to an apparatus (12) for producing a corrugating roller, with a corrugating roller helical toothing having corrugating teeth (7). The method comprises the steps of providing a corrugating roller blank (1) which has a corrugating roller blank central longitudinal axis (3), and machining the corrugating roller blank (1) by means of a machining apparatus (12) having at least one machining device (16), with a relative displacement between the corrugating roller blank (1) and the at least one machining device (16), thereby producing the corrugating roller helical toothing. The present application further relates to a corrugating roller with an improved corrugating roller helical toothing.

### RELATED APPLICATION

This U.S. patent application claims priority to German Patent Application No. 102023204993.7, filed on May 26, 2023, which is hereby incorporated by reference in its entirety.

The present application relates to a method and to an apparatus for producing a corrugating roller which has a corrugating roller helical toothing having corrugating teeth, in particular for a corrugated cardboard plant.

Corrugated cardboard webs with intersecting corrugations or flutes and corresponding apparatuses for their production are known from the prior art. The corrugating rollers of these apparatuses generally have helical toothings. The production of such corrugating rollers is difficult and complex.

The present application is based on the object of providing a method and an apparatus for producing a corrugating roller which has a corrugating roller helical toothing, which overcomes the aforementioned disadvantages of the prior art. In particular, the application addresses a method for producing a corrugating roller which has a corrugating roller helical toothing, which is comparatively simple and extremely efficient.

This object is solved in particular by the features specified in independent claim 1 and the features specified in independent claim 16. The methods and apparatuses described in the present application also make it possible to produce a corrugating roller according to the features of independent claim 21, which has an improved corrugating roller helical toothing and with which the production of corrugated cardboard webs is improved. The core of the invention described herein lies in a relative displacement between a corrugating roller blank and a machining device for producing the corrugating roller helical toothing.

The corrugating roller blank, for example, has a smooth, unstructured peripheral surface. Alternatively, it preferably has a rough toothing made in advance, in particular a rough helical toothing. The corrugating roller blank is one-piece or multi-piece. For example, it is hollow.

The at least one machining device can be driven, for example rotationally driven. It is expedient if the at least one machining device has at least one machining drive or if at least one such machining drive is functionally assigned to the at least one machining device. The at least one machining drive is then preferably a rotary machining drive. The at least one machining device is guided, for example, in particular to produce at least one corrugating tooth and/or at least one corrugating valley over the length thereof. For example, at least one machining device is capable of applying material to and/or removing material from the corrugating roller blank in order to produce the corrugating roller helical toothing. It is advantageously capable of carrying out rough and/or fine machining on the corrugating roller blank. For example, one machining device or multiple machining devices, in particular identically designed ones, are used, which are arranged offset from one another, for example in the longitudinal direction and/or circumferential direction of the corrugating roller blank. The at least one machining device has, for example, at least one negative (shape) region in relation to the corrugating roller helical toothing, in particular of at least one corrugating tooth and/or corrugating valley thereof, which is active during the machining.

It is expedient if at least one displacement drive ensures the relative displacement between the corrugating roller blank and the at least one machining device, in order in particular to produce at least one corrugating tooth and/or at least one corrugating valley over the length thereof. The at least one displacement drive is, for example, an electric drive, a pneumatic drive and/or a hydraulic drive. For the relative movement, the corrugating roller blank and/or the at least one machining device is displaced.

It is advantageous if at least one swivel drive ensures a relative swivel displacement between the corrugating roller blank and the at least one machining device. The at least one swivel drive is, for example, an electric drive, a pneumatic drive and/or a hydraulic drive. For the relative swivel movement, the corrugating roller blank and/or the at least one machining device is displaced. For this purpose, in particular the corrugating roller blank is swiveled (with a precise fit) at a helix angle of the corrugating roller helical toothing, so that the at least one corrugating tooth to be produced is at least temporarily, preferably always, perpendicular to a center of the corrugating roller blank.

The corrugating roller helical toothing advantageously has alternating corrugating teeth and corrugating valleys. It is advisable if the corrugating teeth are all identical. Preferably, the corrugating valleys are identical in shape. It is advantageous if the corrugating teeth and/or corrugating valleys are each formed symmetrically. The corrugating roller helical toothing preferably has heads and feet. It is expedient if each corrugating tooth has flanks and/or is delimited by flanks. The corrugating roller helical toothing preferably forms a surface helical toothing. It is expedient if the corrugating teeth and/or corrugating valleys each form a helix angle of between 0.5° and 8° with the central longitudinal axis of the corrugating roller.

The corrugating roller preferably has a corrugating roller central longitudinal axis and a corrugating roller circumferential direction. It preferably has an axial length between 100 cm and 400 cm. The preferred diameter of the corrugating roller is between 10 cm and 60 cm. It is expedient if the corrugating roller has bearing journals at the end for its mounting. The finished corrugating roller is preferably hardened or surface treated.

Preferably, two corrugating rollers form a corrugating device for corrugating a, in particular endless, material web. They preferably mesh or interlock with each other. During operation, the corrugating teeth of a first corrugating roller advantageously engage in the corrugating valleys of a second corrugating roller, while the corrugating teeth of the second corrugating roller engage in the corrugating valleys of the first corrugating roller. As a result, the originally smooth material web passed through a corrugating gap or roller gap formed between the corrugating rollers is permanently deformed. Preferably, at least one corrugating roller is heatable. It is expedient if the material web is made of cardboard, paper or the like.

The pitch directions of the helical toothings of the corrugating device are advantageously opposite to each other. For example, the first corrugating teeth of the first corrugating roller are left-handed, while the second corrugating teeth of the second corrugating roller are right-handed.

It is expedient if an apparatus having the corrugating device also comprises a glue application device for applying glue to peaks of a corrugation/wave of the material web. It is advantageous if the apparatus further comprises a pressing device for pressing a cover sheet onto the glued peaks of the material sheet. The apparatus is preferably capable of producing a single-side laminated corrugated cardboard web.

Further advantageous embodiments of the invention are specified in the dependent claims.

The method according to dependent claim 2 is extremely reliable and economical. The alignment of the corrugating roller blank and the at least one machining device to each other is carried out, for example, manually or mechanically, in particular automatically. The corrugating roller blank and/or the at least one machining device is aligned accordingly.

The method according to dependent claim 3 is, for example, capable of equipping a corrugating roller with a corrugating roller camber, and/or producing the camber. Such a corrugating roller has a diameter that increases continuously from both ends towards the middle. For example, a linear contact pressure can be maintained between the corrugating rollers of the corrugating device across the entire width. Alternatively or additionally, a sag compensation with respect to the corrugating roller blank is preferably possible during its machining by means of appropriate radial displacement.

It is expedient if, according to dependent claims 4 and 5, the at least one, for example linear, zone of attack of the at least one machining device during the machining of the corrugating roller blank is formed, for example, on at least one, for example groove-like, depression which is (substantially) complementary to at least one corrugating tooth. The at least one depression is preferably asymmetrical (in cross-section). For example, the jaws of each of the machining devices that define a depression have different (axial) widths. In particular, the at least one machining device is at least temporarily, preferably always, exactly perpendicular to/above a center point of the corrugating roller blank center axis, so that the at least one zone of attack is at least temporarily, preferably always, perpendicular to/below a respective machining rotation axis.

In the method according to dependent claim 6, the corrugating roller blank is preferably held in a holding device of the machining apparatus, which can be swiveled, for example, about a vertical axis for the corresponding inclination of the corrugating roller blank. The holding device is preferably held by a frame of the machining apparatus. During the machining of the corrugating roller blank, the holding device and/or the corrugating roller blank preferably extends obliquely to a main plane or zero plane of the machining apparatus. It is expedient if the machining apparatus has at least one guide, in particular a straight guide, for the direct or indirect guidance of the at least one machining device. The at least one guide preferably extends in the main plane or zero plane of the machining apparatus and/or parallel to it. The corrugating roller blank and the at least one machining device are advantageously swiveled relative to each other during machining.

In the method according to dependent claim 7, the at least one machining device can be adjusted or inclined accordingly, for example in its entirety. The corrugating roller blank is preferably held in a holding device of the machining apparatus. The holding device is preferably held by a frame of the machining apparatus. During the machining of the corrugating roller blank, the holding device or the corrugating roller blank preferably extends in a main plane or zero plane of the machining apparatus or parallel to it. It is expedient if the machining apparatus has at least one guide, in particular a straight guide, for the direct or indirect guidance of the at least one machining device. The at least one guide preferably extends in the main plane or zero plane of the machining apparatus or parallel to it. The at least one machining device preferably runs obliquely to the main plane or zero plane of the machining apparatus. The corrugating roller blank and the at least one machining device are advantageously swiveled relative to each other during machining.

The grinding device according to dependent claim 9 is preferably designed as a grinding wheel. It is expedient if it can be driven in rotation for a grinding process, such as by a machining drive.

The milling device according to dependent claim 10 preferably comprises a milling element. It is expedient if it can be driven in rotation for a milling process, such as by a machining drive.

The milling device according to dependent claim 11 is advantageously movable over at least three, preferably five, axes during the milling process. For example, multiple sides of the corrugating roller blank can be machined to produce the corrugating roller helical toothing. The simultaneous milling device preferably comprises a milling head.

The milling device according to dependent claim 12 preferably has a milling worm. It is advisable to carry out roughing before hardening and finishing afterwards. Alternatively or additionally, lapping can take place.

The application device according to dependent claim 13 is capable of producing the corrugating roller helical toothing, in particular corrugating teeth, for example successively, by targeted, such as linear, material application.

The method according to dependent claim 14 removes material in a targeted manner by laser radiation.

It is advantageous if material is removed in the method according to dependent claim 15. Machining preferably takes place in/with an electrically non-conductive medium, such as oil or deionized water. Advantageously, at least one discharge machining device and the corrugating roller blank are arranged at a distance from one another during discharge machining. The at least one machining device and the corrugating roller blank are preferably in a conductive connection with an electrical power source. Eroding is used, for example, to produce the corrugating roller helical toothing. Alternatively, it is used for subsequent machining or treatment of the corrugating roller blank after an initial production of a corrugating roller helical toothing.

In a preferred development of the apparatus for machining a corrugating roller which has a corrugating roller helical toothing having corrugating teeth, the apparatus has:
a holding device for holding a corrugating roller blank with a corrugating roller blank central longitudinal axis; and
a machining device for producing the corrugating roller helical toothing, wherein the holding device and/or the machining device are configured to produce the corrugating roller helical toothing during a relative displacement between the corrugating roller blank and the machining device.

In a preferred development of the apparatus, the holding device is designed to hold the corrugating roller blank by its bearing journal during machining, preferably in such a way that the corrugating roller blank extends horizontally.

In a preferred development of the apparatus, the apparatus further comprises a swivel drive which is in direct or indirect drive connection with the corrugating roller blank and is designed to swivel the corrugating roller blank, preferably continuously, in a circumferential direction about the corrugating roller blank central longitudinal axis during machining.

In a preferred development of the apparatus, the apparatus further comprises an inclination device for tilting the corrugating roller blank perpendicular to its corrugating roller blank central longitudinal axis.

In a preferred development of the apparatus, the inclination device is in direct or indirect drive connection with the holding device and is designed to incline the corrugating roller blank relative to the vertical main plane of the machining apparatus, and wherein the inclination device preferably comprises an inclination drive.

In a preferred development of the apparatus, the machining device comprises a grinding wheel which can be driven in rotation about a central axis of rotation and which comprises at least one grinding projection on its exposed peripheral region, wherein the grinding projection comprises a rounded outer grinding head which is convexly curved with respect to the axis of rotation.

In a preferred development of the apparatus, the grinding wheel comprises at least two grinding projections arranged adjacent to one another, each of which is circumferential and extends around the axis of rotation. Additionally or alternatively (“and/or”), the grinding wheel comprises one or more circumferential grinding grooves each having a rounded inner base, wherein the one or more grinding grooves taper towards their respective base, and the respective base is concavely curved with respect to the axis of rotation.

In a preferred development of the apparatus, the at least one circumferential grinding groove and/or the at least one circumferential grinding projection is designed asymmetrically in order to compensate for an undercut on the helical toothing of the corrugating roller.

In a preferred development of the apparatus, the apparatus further comprises a displacement drive which is in direct or indirect drive connection with the grinding wheel and which is designed to radially displace the grinding wheel with respect to the corrugating roller blank central longitudinal axis, in particular to radially displace it in a guided manner, in order to thereby carry out a sag compensation and/or to equip the corrugating roller with a corrugating roller camber.

The corrugating roller according to the invention for producing corrugated cardboard webs comprises a cylindrical corrugating roller body; and a corrugating roller helical toothing having corrugating teeth and corrugating valleys, wherein the corrugating teeth and corrugating valleys form a helix angle with a central longitudinal axis of the corrugating roller which lies between 0.5° and 8° and thus forms an external helical toothing.

In a preferred development of the corrugating roller, adjacent corrugating teeth run parallel to one another and have an identical distance from one another in a circumferential direction, and wherein the corrugating teeth are preferably designed identically and are evenly distributed over the circumference of the corrugating roller and/or wherein adjacent corrugating valleys extend parallel to one another and have an identical distance from one another in the circumferential direction, and wherein the corrugating valleys are preferably designed identically and are evenly distributed over the circumference of the corrugating roller.

In a preferred development of the corrugating roller, each corrugating tooth has a first flank and a second flank opposite the first flank and a head arranged therebetween, wherein each head is convexly curved with respect to the central longitudinal axis of the corrugating roller.

In a preferred development of the corrugating roller, each head has a constant curvature and the first and second flanks are substantially straight at least in some areas, and the corrugating valleys are concavely curved with respect to the central longitudinal axis and each have a constant curvature.

In a preferred development of the corrugating roller, the corrugating roller helical toothing was produced using the method according to any of the embodiments described in this document and/or using the apparatus according to any of the embodiments described in this document.

The apparatus according to the invention for producing corrugated cardboard webs has: a first corrugating roller according to any of the embodiments described in this document and a second corrugating roller according to any of the embodiments described in this document, wherein the corrugating teeth of the first corrugating roller engage in the corrugating valleys of the second corrugating roller, while the corrugating teeth of the second corrugating roller engage in the corrugating valleys of the first corrugating roller; wherein a pitch direction of the helical toothing of the first corrugating roller is opposite to a pitch direction of the helical toothing of the second corrugating roller, wherein preferably at least the first corrugating roller is heatable, and wherein the apparatus further preferably has a glue application device for applying glue to peaks of a corrugation of the corrugated cardboard web and a pressing device for pressing a cover sheet onto the peaks of the corrugated cardboard web provided with glue.

Preferred embodiments of the invention are described below by way of example with reference to the accompanying drawings, wherein:

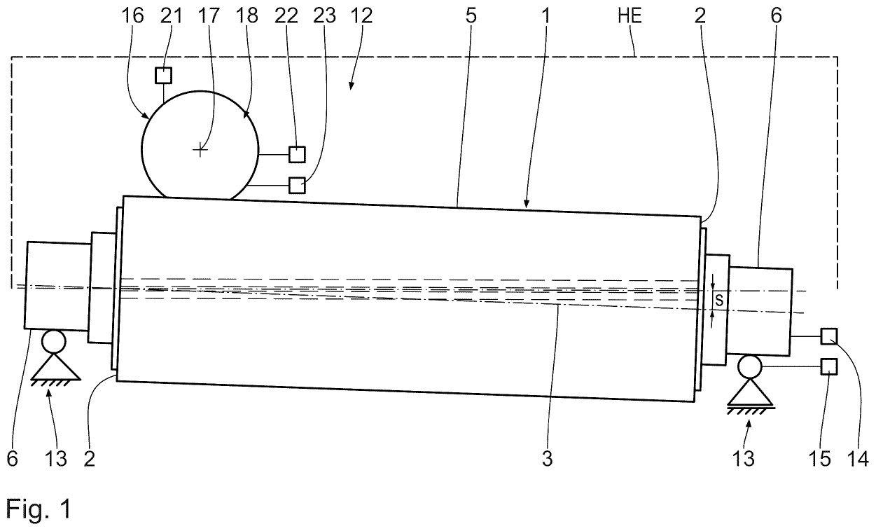

FIG. 1 shows a schematic view of a corrugating roller blank and a machining apparatus for machining the same, for carrying out a method according to the invention,

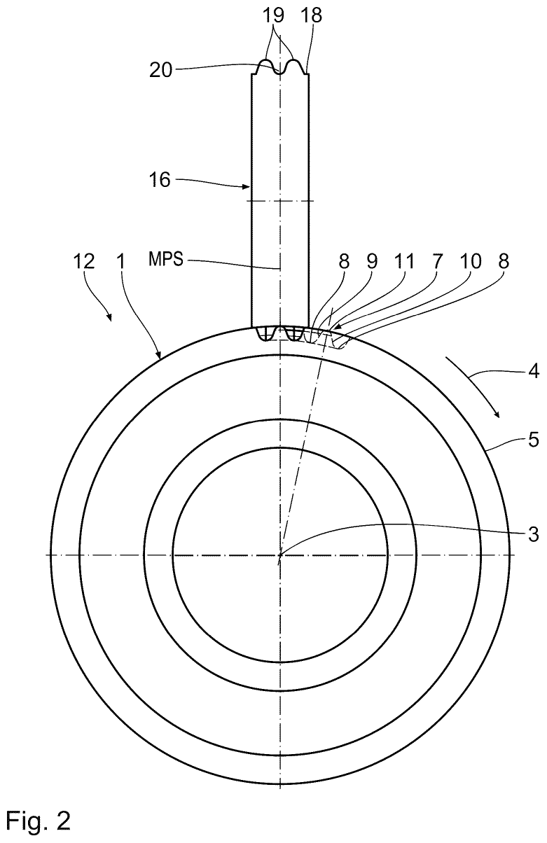

FIG. 2 shows substantially a front view of the machining apparatus illustrated in FIG. 1 including the corrugating roller blank,

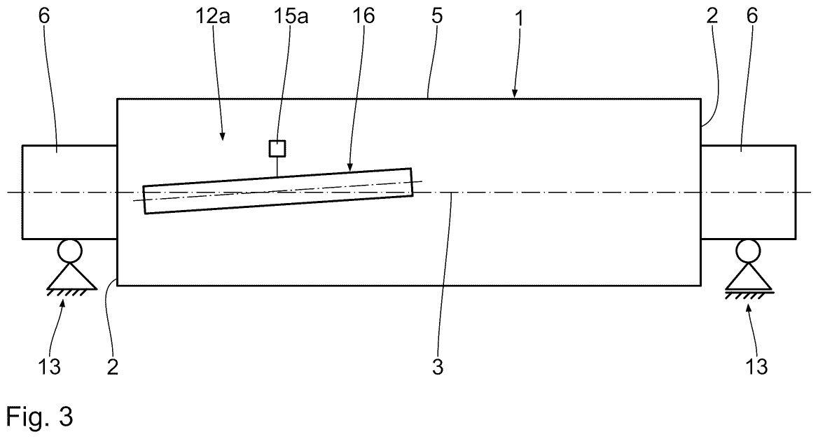

FIG. 3 shows a schematic view of a corrugating roller blank and an alternative machining apparatus for carrying out an alternative method according to the invention,

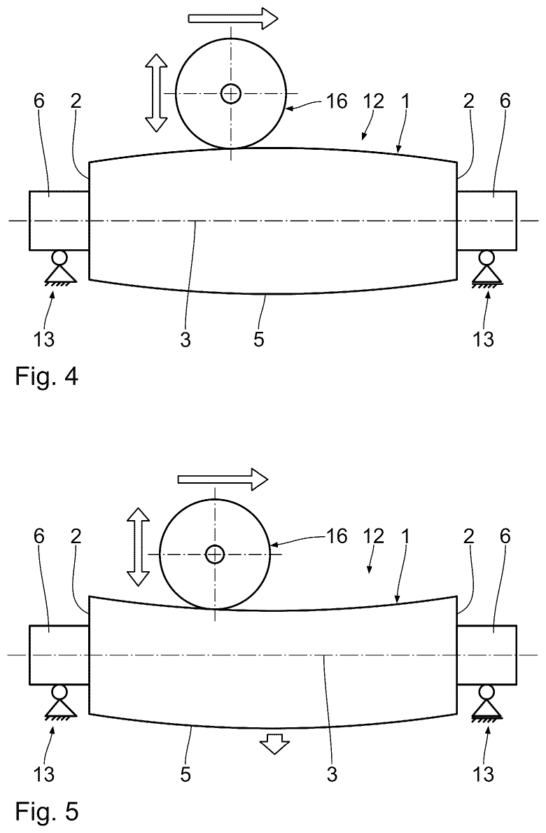

FIG. 4 shows a schematic view showing the production of a corrugating roller camber,

FIG. 5 shows a schematic view illustrating sag compensation,

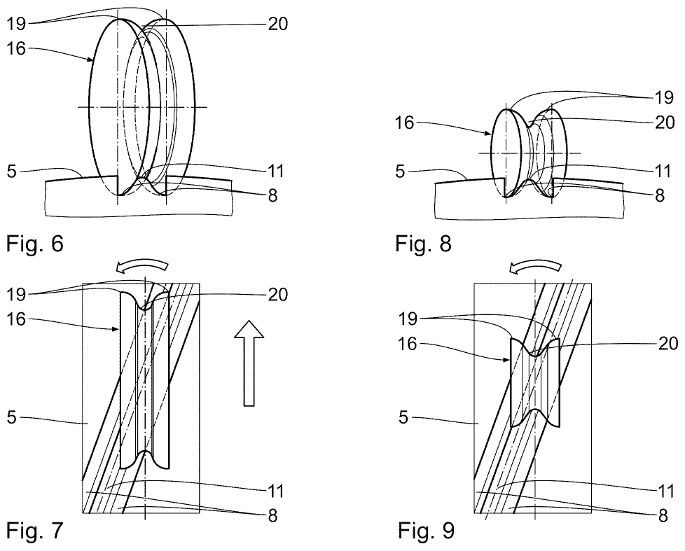

FIGS. 6 to 9 show schematic views illustrating a method for undercut compensation according to the invention,

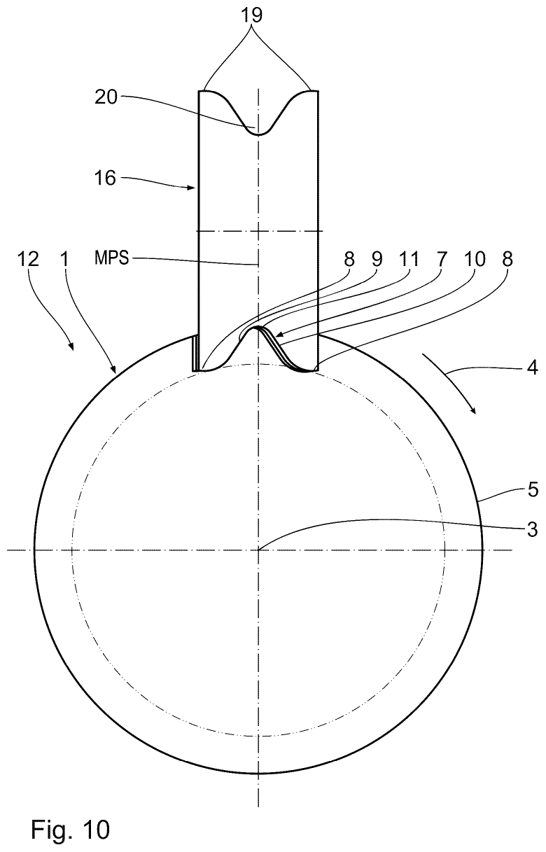

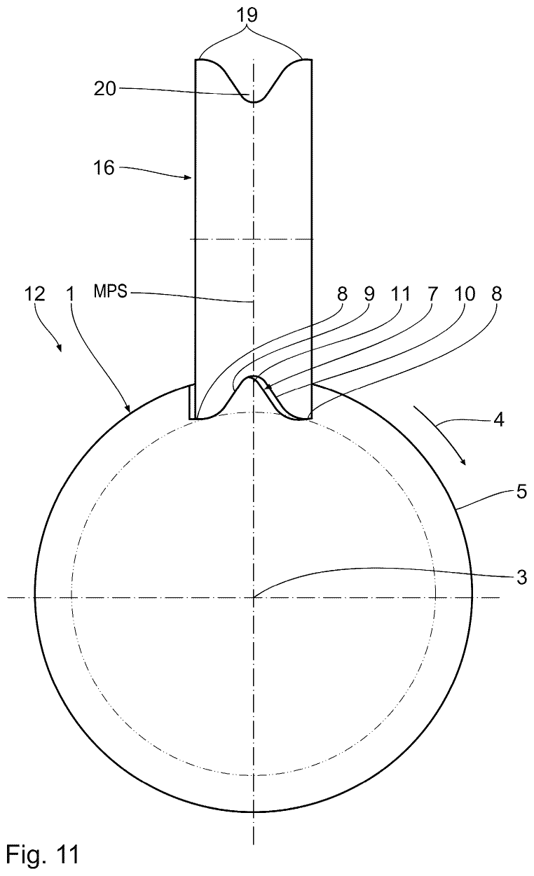

FIGS. 10, 11 show schematic views of a machining apparatus and a corrugating roller blank showing a method according to the invention for undercut compensation,

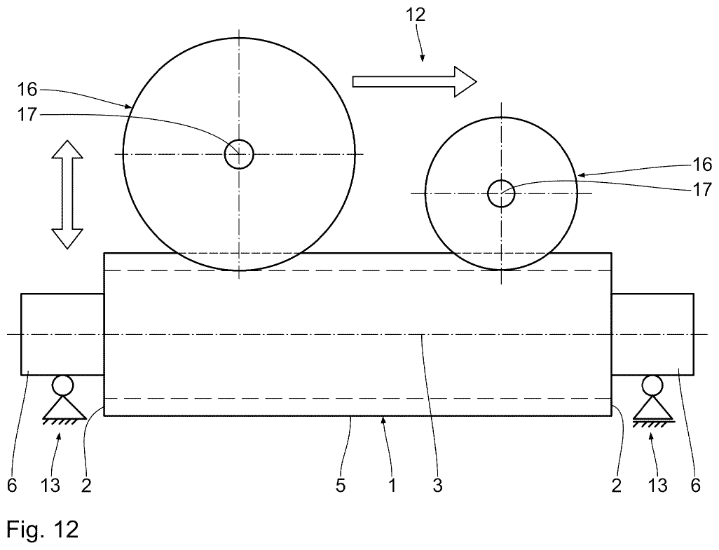

FIG. 12 shows a schematic view of a corrugating roller blank and a machining apparatus, wherein machining devices thereof are shown in different states of wear; and a method according to the invention for undercut compensation is illustrated,

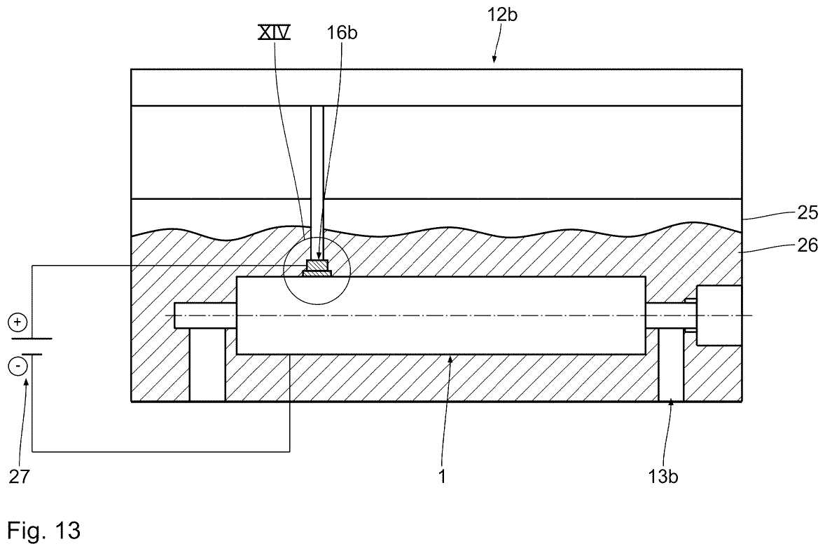

FIG. 13 shows a schematic view of a corrugating roller blank and an alternative machining apparatus for machining the same, for carrying out an alternative method according to the invention,

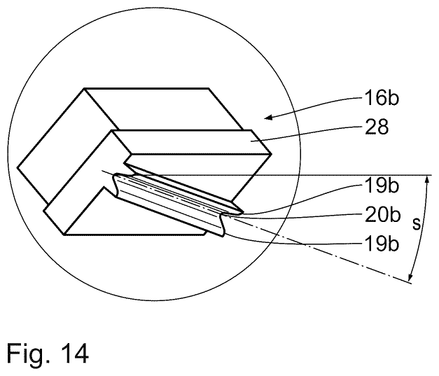

FIG. 14 shows the detail marked in FIG. 13 in an enlarged scale,

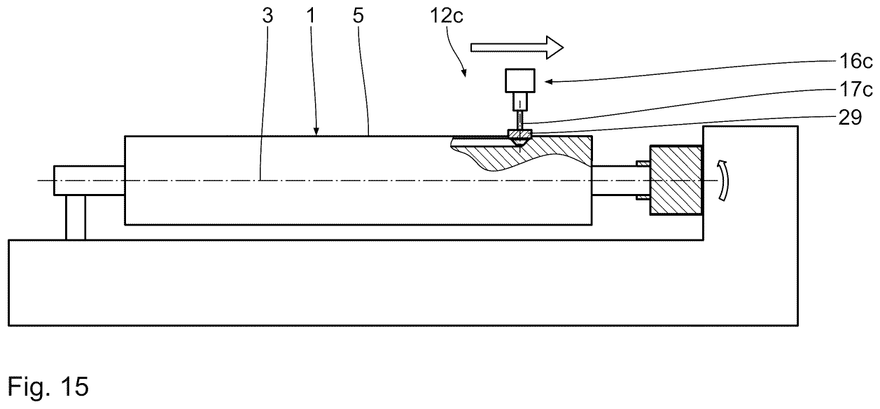

FIG. 15 shows a schematic view of a corrugating roller blank and an alternative machining apparatus for machining the same, for carrying out an alternative method according to the invention,

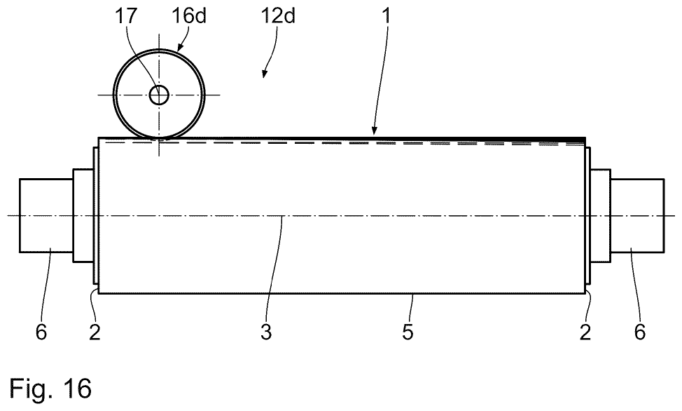

FIG. 16 shows a schematic view of a corrugating roller blank and an alternative machining apparatus for machining the same, for carrying out an alternative method according to the invention,

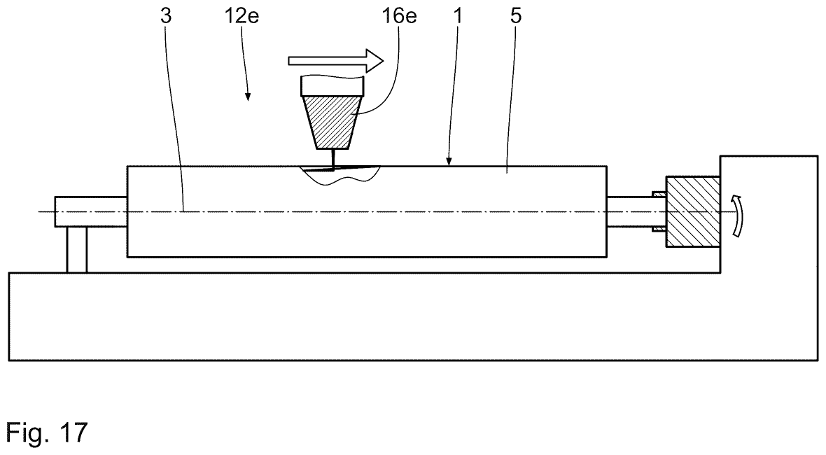

FIG. 17 shows a schematic view of a corrugating roller blank and an alternative machining apparatus for machining the same, for carrying out an alternative method according to the invention, and

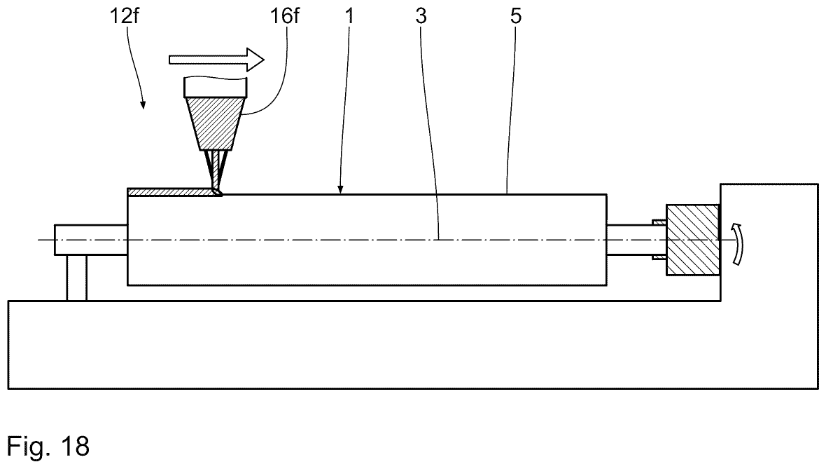

FIG. 18 shows a schematic view of a corrugating roller blank and an alternative machining apparatus for machining the same, for carrying out an alternative method according to the invention.

Referring first to FIGS. 1, 2, a corrugating roller blank 1 shown therein as a starting body for producing a corrugating roller has two opposite ends 2 and a corrugating roller blank central longitudinal axis 3 which coincides with an axis of rotation or central longitudinal axis of the finished or usable corrugating roller. The corrugating roller blank 1 also has a circumferential direction 4 around the corrugating roller blank central longitudinal axis 3, which coincides, for example, with a direction of rotation of the corrugating roller during use.

The corrugating roller blank 1 further has a cylindrical corrugating roller blank roller body 5. It also comprises two end-face, aligned bearing journals 6 for mounting the corrugating roller.

The finished corrugating roller has a large number of external corrugating teeth arranged around the circumference. Between adjacently arranged corrugating teeth, there are corrugating valleys. As shown in FIG. 2, the corrugating roller blank 1 has a corrugating tooth on its corrugating roller blank roller body 5, which is assigned the reference number 7. The corrugating tooth 7 is arranged between two corrugating valleys, which are assigned the reference number 8.

Adjacent corrugating teeth 7 run parallel to each other and have an identical distance from each other in the circumferential direction 4. They are preferably identical and evenly distributed around the circumference. Neighboring corrugating valleys 8 also extend parallel to one another and have an identical distance from one another in the circumferential direction 4. They are preferably identical in design and have an identical distance from one another. They are evenly distributed around the circumference. The corrugating teeth 7 and corrugating valleys 8 form an external toothing. They form a helix angle s with the central longitudinal axis 3 of the corrugating roller which lies between 0.5° and 8° (see FIG. 1). The toothing thus forms a helical toothing, in particular an external helical toothing.

As shown in FIG. 2, the or each corrugating tooth 7 has a first flank 9 and a second flank 10 opposite thereto as well as a head 11 arranged between them. Each head 11 is convexly curved relative to the central longitudinal axis 3 of the corrugating roller. It preferably has a constant curvature. For example, flanks 9, 10 are (substantially) straight, at least in some areas.

The corrugating valleys 8 preferably each have a constant curvature. They are concavely curved with respect to the central longitudinal axis 3.

A machining apparatus 12, which is shown in a highly simplified manner in FIGS. 1 and 2, is used to process the corrugating roller blank 1 or to produce the corrugating roller from the corrugating roller blank 1.

The machining apparatus 12 has a holding device 13 for holding the corrugating roller blank 1, preferably by its bearing journal 6, during machining. It preferably holds the corrugating roller blank 3 in such a way that it extends horizontally. The holding device 13 is held, for example, by a frame of the machining apparatus 12.

Furthermore, the machining apparatus 12 preferably has a swivel drive 14 which is in direct or indirect drive connection with the corrugating roller blank 1 and is capable of swiveling the corrugating roller blank 1, preferably continuously, during machining in the circumferential direction 4, or opposite this direction, about the corrugating roller blank central longitudinal axis 3.

The machining apparatus 12 also comprises an inclination device 15, which is preferably in direct or indirect drive connection with the holding device 13. The inclination device 15 is preferably capable of inclining the holding device 13 or the corrugating roller blank 1 to be machined relative to a vertical main plane or zero plane of the machining apparatus. It preferably has at least one inclination drive. The corrugating roller blank 1 can thus be deflected or tilted perpendicular to its corrugating roller blank central longitudinal axis 3.

The machining apparatus 12 also has a machining device 16, which is designed here as a grinding wheel. The grinding wheel 16 is circular and has a central axis of rotation 17. It can be driven to rotate about the axis of rotation 17.

The grinding wheel 16 comprises, on its exposed peripheral region 18, at least one grinding projection 19, preferably at least two identical grinding projections 19 arranged adjacent to one another, each of which is/are circumferential and extends around the axis of rotation 17. The grinding projections 19, if there are more than one, are arranged uniformly axially spaced from one another in the direction of the axis of rotation 17. Each grinding projection 19 has a rounded outer grinding head which is convexly curved with respect to the axis of rotation 17. For example, the grinding wheel 16 has two or three grinding projections 19.

Between adjacently arranged grinding projections 19, if more than one is present, the grinding wheel 16 has a circumferential grinding groove 20 with a respective rounded inner base. Each grinding groove 20 tapers towards its respective base. Each base is concavely curved with respect to the axis of rotation 17.

The grinding projection 19 or the grinding projections 19 or the grinding groove(s) 20 is/are designed in size and shape as well as arrangement such that it/they is/are suitable for forming the corrugating teeth 7 or corrugating valleys 8.

The grinding wheel 16 is radially displaceable with respect to the corrugating roller blank central longitudinal axis 3, in particular radially displaceable with guidance, for example vertically or horizontally displaceable. Its (radial) distance to the corrugating roller blank central longitudinal axis 3 is thus adjustable. For this purpose, the machining apparatus 12 has a displacement drive 21 which is in direct or indirect drive connection with the grinding wheel 16.

The grinding wheel 16 is also displaceable between the ends 2 of the corrugating roller blank 1. It can be moved along the corrugating roller blank 1. For this purpose, the machining apparatus 12 has a displacement drive 22 which is in direct or indirect drive connection with the grinding wheel 16. It also has a straight guide along which a carriage can be moved. The carriage holds, directly or indirectly, the grinding wheel 16. The straight guide extends in a vertical machining apparatus main plane MP or zero plane or parallel to it.

The grinding wheel 16 can be rotated about its axis of rotation 17. For this purpose, the machining apparatus 12 comprises a rotary drive 23 which is in direct or indirect drive connection with the grinding wheel 16.

For the production of the corrugating roller or the creation of the helical toothing on the corrugating roller blank 1, the corrugating roller blank 1 held by the holding device 13 is first inclined by means of the inclination device 15 according to a target offset of the helical toothing of the corrugating roller with respect to the corrugating roller blank central longitudinal axis 3 or the helix angle s. The corrugating roller blank 1 is thus positioned in the holding device 13 at an angle relative to the main plane MP of the machining apparatus. The grinding wheel 16 is located, for example, in the main plane MP of the machining apparatus or runs parallel to it.

Subsequently, the grinding wheel 16 is brought into its machining position or grinding position adjacent to one end 2 by means of the displacement drive 21. When the grinding wheel 16 is in its grinding position, the grinding projections 19, if there is more than one, or the at least one grinding projection 19 of the grinding wheel 16, set in rotation by means of the rotary drive 23, engage the corrugating roller blank 1 in a grinding manner. This creates a material machining drive.

The grinding wheel 16 is displaced along the at least one corrugating tooth 7 to be produced in the direction of the remote end 2 by means of the displacement drive 22 by means of/along the straight guide. The swivel drive 14 swivels the corrugating roller blank 1 about its corrugating roller blank central longitudinal axis 3 accordingly. The corrugating roller blank 1 is swiveled to match the helix angle s so that the corrugating tooth 7 to be produced is always perpendicular to a center of the corrugating roller blank 1. Preferably, the corrugating roller blank 1 is always ground at the highest point.

After this first grinding step, the corrugating roller blank 1 is swiveled in its circumferential direction 4 by means of the swivel drive 14. The grinding wheel 16 is lifted off the corrugating roller blank 1 by means of the displacement drive 21. For example, the corrugating roller blank 1 is swiveled in such a way that in a next grinding step a corrugating tooth 7 is machined again in order to effect an additional material removal. Alternatively, at least one corrugating tooth 7 is newly created. The grinding process is then repeated to produce it.

As shown in FIG. 2, during the grinding process a main plane MPS of the grinding wheel 16 passes through the corrugating roller blank central longitudinal axis 3. The main plane MPS lies in the grinding wheel 16 and extends perpendicular to the axis of rotation 17. Undercuts can be reduced or avoided.

An alternative machining apparatus 12a is described below with reference to FIG. 3. Identical parts are given the same reference numerals as in the previous embodiment, to which explicit reference is hereby made. Structurally different but functionally similar parts are given the same reference numerals with a subsequent “a.”

In comparison with the previous embodiment, the machining apparatus 12a has no inclination device 15 which is in direct or indirect drive connection with the holding device 13. For this purpose, an inclination device 15a is directly or indirectly connected to the grinding wheel 16, and is capable of inclining the grinding wheel 16 with respect to the corrugating roller blank 1 or the corrugating roller blank central longitudinal axis 3. The grinding wheel 16 thus has an additional degree of freedom compared to the previous embodiment.

In contrast to the previous embodiment, the grinding wheel 16 is adjusted by means of the inclination device 15a according to a target offset of the corrugating roller helical toothing or the helix angle s and is then displaced multiple times in its grinding position in the direction of the remote end 2 of the corrugating roller blank 1 longitudinally or by means of the straight guide, to produce the helical toothing. The swivel drive 14 swivels the corrugating roller blank 1 about its corrugating roller blank central longitudinal axis 3 accordingly.

It is again important that the main plane MPS of the grinding wheel 16 passes through the corrugating roller blank central longitudinal axis 3 during the grinding process.

As illustrated in FIG. 4, the corrugating roller blank 1 has a camber. For this purpose, it is necessary for the grinding wheel 16 to be adjusted in its distance from the corrugating roller blank central longitudinal axis 3 by means of the displacement drive 21 when producing the helical toothing according to the camber. The grinding wheel 16 substantially follows the outer shape of the corrugating roller blank 1.

By means of the displacement drive 21, the grinding wheel 16 is also able to perform sag compensation (FIG. 5). The grinding wheel 16 substantially follows the outer shape of the corrugating roller blank 1.

In order to compensate for an undercut on the helical toothing of the corrugating roller, an undercut that occurs on the corrugating roller is preferably taken into account when generating an individual profile on the grinding wheel 16. The profile of the grinding wheel 16 is designed or constructed in such a way that the expected undercut on the corrugating roller is compensated by a previously determined arcuate projection. Compensation is carried out in such a way that a profile shape that can be achieved on the corrugating roller can still be achieved after grinding.

As FIGS. 6 to 12 illustrate, during the grinding process a circumferential zone of attack of the grinding wheel 16 is not parallel to the axis of rotation 17; rather, it is oblique to it. The inclination of the zone of attack depends on the helical toothing of the corrugating roller and/or the helix angle s. It is defined by a vertical point in the middle of the coating thickness as well as attack points shifted in the longitudinal direction of the corrugating roller blank 1 at the respective grinding wheel edges. It is necessary to ensure individual profile design via a dressing process realized by machine axes. It is expedient if, for the undercut compensation, each grinding groove 20 is not mirror-symmetrical, and rather is asymmetrical. The grinding projections 19 delimiting the respective grinding grooves 20 are, for example, designed accordingly differently (FIGS. 6 to 11).

A profile shape depends on a current grinding wheel diameter, which requires continuous adjustment. In particular, the design of the grinding groove(s) 20 and/or the grinding projections 19 depends on the current diameter of the grinding wheel 16. For example, as shown in FIG. 12, the diameter of the grinding wheel 16 decreases due to wear during the grinding process, so that its engagement changes with respect to its diameter.

An alternative machining apparatus 12b is described below with reference to FIG. 13. Identical parts are given the same reference numerals as in the embodiments according to FIGS. 1, 2 and 3, to whose description explicit reference is hereby made. Structurally different but functionally similar parts are given the same reference numerals with a subsequent “b.”

In comparison with the embodiment according to FIG. 3, the holding device 13b is located in a basin 25 of the machining apparatus 12b. During machining, the corrugating roller blank 1 is also located in the basin 25. The basin 25 is filled with a dielectric 26 which completely surrounds the corrugating roller blank 1 during machining of the corrugating roller blank 1.

The machining device 16b is designed as a discharge machining electrode. The discharge machining electrode 16b and the corrugating roller blank 1 are each electrically connected to a direct current source 27 via an electrical cable. The corrugating roller blank 1 acts as a cathode, while the machining device 16b acts as an anode.

As shown in FIG. 14, the discharge machining electrode 16b has two discharge machining projections 19b and a discharge machining groove 20b arranged between them. A different number of discharge machining projections 19b and discharge machining grooves 20b is alternatively possible. The discharge machining electrode 16b again forms a negative shape. The grinding projections 19b and grinding groove 20b extend, for example, obliquely to an associated support body 28. The inclination corresponds to the helical toothing and/or the helix angle s.

During the discharge machining process for producing the helical toothing, the discharge machining electrode 16b is brought to the corrugating roller blank 1. Electrical discharge processes are brought about between the corrugating roller blank 1 and the discharge machining electrode 16b, whereby material of the corrugating roller blank 1 melts and evaporates at certain points. In order to form the helical toothing, the discharge machining electrode 16b is displaced multiple times between the ends 2 lengthwise and/or by means of the straight guide. The corrugating roller blank 1 is swiveled. If a contour electrode is used, the profile angle must be taken into account accordingly.

The production of helical toothings by means of discharge machining can be carried out in a similar way to the production of helical toothings by grinding, but a discharge machining electrode is used instead of the grinding wheel. During discharge machining, the corrugating roller blank 1 is swiveled to create a profile bevel.

Erosion is carried out, for example, as post-machining of a roughing process that has been created by milling. After roughing, the corrugating roller blank 1 is hardened and then finished by discharge machining into the hardened surface. Preferably, sinking electrical discharge machining or 3D electrical discharge machining milling is used if the milling and electrical discharge machining take place on the same machining apparatus 12b. The sinking electrical discharge machining can be carried out using contour electrodes, whereby multiple contour electrodes can also be used over the circumference of the corrugating roller blank 1.

An alternative embodiment of the machining apparatus 12c is described below with reference to FIG. 15. Identical parts are given the same reference numerals as in the previous embodiments, to the description of which reference is made. Structurally different but functionally similar parts are given the same reference numerals with a subsequent “c.”

In comparison with the previous embodiments, the machining device 16c is designed as a milling device which has a milling head 29 tapering towards its free end. The milling head 29 is designed corresponding to the helical toothing, in particular corresponding to at least one corrugating tooth 7 and/or corrugating valley 8. Multi-axis simultaneous milling is preferred.

In order to produce the helical toothing, the milling head 29 is rotated about its central axis or axis of rotation 17 and is displaced multiple times, for example along or by means of the straight guide. The corrugating roller blank 1 is preferably swiveled accordingly. The axis of rotation 17 preferably extends at least temporarily in the direction of the corrugating roller blank central longitudinal axis 3.

Rough machining is advantageously carried out in an unhardened state of the corrugating roller blank 1 via multi-axis simultaneous milling with the milling head 29. Subsequently, the corrugating roller body 1, which is provided with helical toothing, is inductively hardened. This is followed by multi-axis simultaneous hard milling on the corrugating roller blank 1 for finishing. Optionally, lapping can be carried out in a roller inlet frame to even out milling marks. Programming of the milling head 29 is preferably carried out via a three-dimensional model of the corrugating roller.

An alternative machining device 16d is described below with reference to FIG. 16. Identical parts are given the same reference numerals as in the previous embodiments, to whose description explicit reference is made. Structurally different but functionally similar parts are given the same reference numerals with a subsequent “d.”

The machining device 16d is designed here as a hobbing element and/or rolling body. The hobbing element 16d is, for example, a worm, preferably with clamping grooves, and forms a worm gear with the corrugating roller blank 1. A profile-dependent creation of the machining device 16d is necessary.

To produce the helical toothing, the hobbing element 16d is set in rotation about its axis of rotation 17 and is displaced multiple times along/by means of the straight guide. The corrugating roller blank 1 is preferably swiveled accordingly.

Preferably, a roughing process is carried out before hardening the corrugating roller blank 1. Preferably, a finishing operation is carried out afterwards. Lapping can be carried out optionally, for example in a roller inlet frame.

An alternative machining apparatus 12e is described below with reference to FIG. 17. Identical parts are given the same reference numerals as in the previous embodiments, to whose description explicit reference is made. Structurally different but functionally similar parts are given the same reference numerals with a subsequent “e.”

The machining device 16e is designed as a laser structuring device which is capable of engraving helical toothing. For example, a USP (ultra-short pulse) laser is used, as this avoids heat input and thus changes in the material properties of the corrugating roller blank 1. The geometry that is generated by the machining device 16e is created digitally in advance and is relayed to a controller of the machining device 16e. Beam guidance is achieved, for example, via an axis controller which guides a lens and/or a scanner. The corrugating roller blank 1 is preferably swiveled during its machining. The machining device 16e is advantageously displaced multiple times by means of the straight guide.

Multiple machining devices 16e can be used.

An alternative machining apparatus 12f will be described below with reference to FIG. 18. Identical parts are given the same reference numerals as in the previous embodiments, to which reference is made. Structurally different but functionally similar parts are given the same reference numerals with a subsequent “f.”

The machining device 16f is designed here as a laser cladding device. The helical toothing is applied and/or deposited on the corrugating roller blank 1. The added material can be applied in common forms such as powder, wire or the like. A combination of welding and targeted modification of material properties of the corrugating roller blank 1 by heat input and additional material is possible. The geometry that is generated by the machining device 16f is created digitally in advance and is relayed to a controller of the machining device 16f and a beam guide, as well as a welding head. Beam guidance can be achieved either via an axis controller that guides a lens and/or via a scanner.

The corrugating roller blank 1 is swiveled. The machining device 16f is advantageously displaced multiple times by means of the straight guide.

For example, multiple machining devices 16f are used.

Combinations of the above embodiments are possible.

1. Method for producing a corrugating roller which has a corrugating roller helical toothing with corrugating teeth, comprising the steps of:
providing a corrugating roller blank which has a corrugating roller blank central longitudinal axis, and
machining the corrugating roller blank by means of a machining apparatus having at least one machining device, with a relative displacement between the corrugating roller blank and the at least one machining device to produce the corrugating roller helical toothing.

2. Method according to claim 1, characterized by
aligning the corrugating roller blank and the at least one machining device relative to one another according to a target offset of the corrugating roller helical toothing with respect to the corrugating roller blank central longitudinal axis, and
displacing the corrugating roller blank and the at least one machining device relative to one another, wherein the at least one machining device engages the corrugating roller blank in a machining manner to produce the corrugating roller helical toothing.

3. Method according to claim 1, characterized by radially displacing the at least one machining device and the corrugating roller blank relative to one another with respect to the corrugating roller blank central longitudinal axis.

4. Method according to claim 1, characterized in that, for undercut compensation, at least one zone of attack of the at least one machining device on the corrugating roller blank is inclined with respect to each of the machining device rotation axes of the at least one machining device.

5. Method according to claim 1, characterized by aligning the at least one machining device and the corrugating roller blank such that the at least one machining device is always perpendicular to the corrugating roller blank central longitudinal axis and at least one zone of attack of the at least one machining device on the corrugating roller blank is always perpendicular to a respective machining device rotation axis of the at least one machining device.

6. Method according to claim 1, characterized by
inclining the corrugating roller blank according to a target offset of the corrugating roller helical toothing relative to the corrugating roller blank central longitudinal axis, and
displacing the at least one machining device along the corrugating roller blank, wherein the at least one machining device engages the corrugating roller blank in a machining manner.

7. Method according to claim 1, characterized by
inclining the at least one machining device according to a target offset of the corrugating roller helical toothing with respect to the corrugating roller blank central longitudinal axis, and
displacing the at least one machining device along the corrugating roller blank to produce the corrugating roller helical toothing, wherein the at least one machining device engages the corrugating roller blank (1) in a machining manner.

8. Method according to claim 1, characterized in that the at least one machining device is a machining device for machining the corrugating roller blank.

9. Method according to claim 8, characterized in that the at least one machining device is a grinding device for grinding the corrugating roller blank.

10. Method according to claim 1, characterized in that the at least one machining device is a milling device for milling the corrugating roller blank.

11. Method according to claim 10, characterized in that the milling device is a simultaneous milling device.

12. Method according to claim 10, characterized in that the milling device is a hobbing device.

13. Method according to claim 1, characterized in that the at least one machining device is an application device, in particular a laser application device, which applies material to the corrugating roller blank for producing the corrugating roller helical toothing.

14. Method according to claim 1, characterized in that the machining device is a laser removal device which removes material from the corrugating roller blank to produce the corrugating roller helical toothing.

15. Method according to claim 1, characterized by eroding the corrugating roller blank.

16. Apparatus for machining a corrugating roller with a corrugating roller helical toothing having corrugating teeth, comprising
a holding device for holding a corrugating roller blank with a corrugating roller blank central longitudinal axis; and
a machining device for producing the corrugating roller helical toothing, wherein the holding device and/or the machining device are configured to produce the corrugating roller helical toothing during a relative displacement between the corrugating roller blank and the machining device.

17. Apparatus according to claim 16, wherein the holding device is arranged to hold the corrugating roller blank during machining by its bearing journal, preferably in such a way that the corrugating roller blank extends horizontally.

18. Apparatus according to claim 16, further comprising: a swivel drive which is in direct or indirect drive connection with the corrugating roller blank and is designed to swivel the corrugating roller blank, preferably continuously, in a circumferential direction about the corrugating roller blank central longitudinal axis during machining.

19. Apparatus according to claim 16, further comprising an inclination device for tilting the corrugating roller blank perpendicular to its corrugating roller blank central longitudinal axis.

20. Apparatus according to claim 19, wherein the inclination device is in direct or indirect drive connection with the holding device and is designed to incline the corrugating roller blank relative to the vertical main plane of the machining apparatus, and wherein the inclination device preferably comprises an inclination drive.

21. Corrugating roller for producing corrugated cardboard webs, comprising:
a cylindrical corrugating roller body;
a corrugating roller helical toothing having corrugating teeth and corrugating valleys, wherein the corrugating teeth and corrugating valleys form a helix angle with a central longitudinal axis of the corrugating roller which lies between 0.5° and 8°, and thus forms an external helical toothing.

22. Corrugating roller according to claim 21, wherein adjacent corrugating teeth run parallel to one another and have an identical distance from one another in a circumferential direction, and wherein the corrugating teeth are preferably designed identically and are evenly distributed over the circumference of the corrugating roller, and/or wherein adjacent corrugating valleys extend parallel to one another and have an identical distance from one another in the circumferential direction, and wherein the corrugating valleys are preferably designed identically and are evenly distributed over the circumference of the corrugating roller.

23. Corrugating roller according to claim 21, wherein each corrugating tooth has a first flank and a second flank opposite the first flank, and a head arranged therebetween, wherein each head is convexly curved with respect to the central longitudinal axis of the corrugating roller.

24. Corrugating roller according to claim 23, wherein each head has a constant curvature and the first and second flanks are substantially straight at least in regions, and wherein the corrugating valleys are concavely curved with respect to the central longitudinal axis and each have a constant curvature.

25. Corrugating roller according to claim 21, wherein the corrugating roller helical toothing was produced by the method of (i) providing a corrugating roller blank which has a corrugating roller blank central longitudinal axis, and (ii) machining the corrugating roller blank by means of a machining apparatus having at least one machining device, with a relative displacement between the corrugating roller blank and the at least one machining device to produce the corrugating roller helical toothing.

26. Apparatus for producing corrugated cardboard webs, comprising:
a first corrugating roller according to claim 21 and a second corrugating roller according to claim 21, wherein the corrugating teeth of the first corrugating roller engage the corrugating valleys of the second corrugating roller, while the corrugating teeth of the second corrugating roller engage the corrugating valleys of the first corrugating roller;
wherein a pitch direction of the helical toothing of the first corrugating roller is opposite to a pitch direction of the helical toothing of the second corrugating roller, wherein preferably at least the first corrugating roller is heatable, and
wherein the apparatus preferably further comprises a glue application device for applying glue to peaks of a corrugation of the corrugated cardboard web and a pressing device for pressing a cover sheet onto the glued peaks of the corrugated cardboard web.
